(19) United States
(12) Patent Application Publication
(10) Pub. No.: US 2006/0113312 A2
(43) Pub. Date: Jun. 1, 2006

(54) REFRIGERATOR

(75) Inventors: Dong-in SHIN, Kwangsan-gu (KR); Jae-sek OH, Buk-gu (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si, Gyeonggi-do (KR)

(21) Appl. No.: 10/821,169

(22) Filed: Apr. 9, 2004

(30) Foreign Application Priority Data
Jan. 28, 2004 (KR) 10-2004-0005427

(51) Int. Cl. E05D 7/06

(52) U.S. Cl. 220/752

(57) ABSTRACT

Abstract of the Disclosure

The present invention relates to a refrigerator in which a door handle assembly is mounted in a front of a door to facilitate an opening/closing operation of the door. The refrigerator comprising a body provided with storage compartments; a door hingedly coupled to the body and selectively opening/closing the storage compartments; and a door handle assembly mounted in a front of the door, the door handle assembly comprising: a door handle formed with a bracket accommodating portion and a first coupling portion adjacent to the bracket accommodating portion; and a supporting bracket installed in the front of the door to be accommodated in the bracket accommodating portion and having a second coupling portion locked to the first coupling portion by sliding the door handle. With this configuration, the present invention provides a refrigerator having an improved structure of mounting a door handle assembly to a door, in which the door handle assembly is easily mounted to and separated from the door and a cost due to packing and carrying the refrigerator is reduced.

### Detailed Description of the Invention

### CROSS-REFERENCE TO RELATED APPLICATIONS

This application claims the benefit of Korean Patent Application No. 2004-5427, filed Jan. 28, 2004, in the Korean Intellectual Property Office, the disclosure of which is incorporated herein by reference.

### Field of the Invention

The present invention relates to a refrigerator, and more particularly, to a refrigerator in which a door handle assembly is mounted in a front of a door to facilitate an opening/closing operation of the door.

### Description of the Related Art

Generally, a refrigerator is an appliance for storing food or other substances at low temperature, wherein the food or other substances can be kept fresh for a long time with cold generated from an evaporator due to heat exchange according to a refrigerating cycle.

A conventional refrigerator comprises a body provided with storage compartments; a door hingedly coupled to the body and selectively opening/closing the storage compartments; and a door handle assembly mounted in a front of the door. Particularly, the door handle assembly is firmly mounted to the door by a screw or the like and facilitates an opening/closing operation of the door.

Most of conventional refrigerators having the foregoing configuration is packed in the state that the door handle assembly is mounted to the door or in the state that the door handle assembly is separated from the door so as to be mounted to the door when the refrigerator is installed.

In the case where the refrigerator is packed in the state that the door handle assembly is mounted to the door, the packing size of the refrigerator is increased because the door handle assembly protrudes from the front of the door of the refrigerator. Thus, there arise problems that a cost such as a packaging cost, a physical distribution cost, etc. is increased, thereby increasing a unit price of the refrigerator.

In the case where the refrigerator is packed in the state that the door handle assembly is separated from the door, there arise problems that a separate tool is needed for coupling the door handle assembly with the door when the refrigerator is installed; the door handle assembly should be packed individually; and it takes a relatively long time to couple the door handle assembly with the door.

### SUMMARY OF THE INVENTION

Accordingly, it is an aspect of the present invention to provide a refrigerator having an improved structure of mounting a door handle assembly to a door.

Additional aspects and/or advantages of the invention will be set forth in part in the description which follows and, in part, will be obvious from the description, or may be learned by practice of the invention.

The foregoing and/or other aspects of the present invention are achieved by providing a refrigerator comprising a body provided with storage compartments; a door hingedly coupled to the body and selectively opening/closing the storage compartments; and a door handle assembly mounted in a front of the door, the door handle assembly comprising: a door handle formed with a bracket accommodating portion and a first coupling portion adjacent to the bracket accommodating portion; and a supporting bracket installed in the front of the door to be accommodated in the bracket accommodating portion and having a second coupling portion locked to the first coupling portion by sliding the door handle.

According to an aspect of the invention, the supporting bracket is formed with supporters at opposite ends thereof, and the door handle is formed with a sliding guide to support the supporters while sliding.

According to an aspect of the invention, the first coupling portion and the second coupling portion are hook-locked to each other.

According to an aspect of the invention, the door handle comprises a front cover; and a rear cover detachably coupled with the front cover and formed with the bracket accommodating portion, the first coupling portion and the sliding guide.

According to an aspect of the invention, the refrigerator further comprises a reinforcing cover detachably connected onto the rear cover, wherein the reinforcing cover is formed with a separation hole at a position corresponding to the first coupling portion of the rear cover.

### BRIEF DESCRIPTION OF THE DRAWINGS

These and other aspects and advantages of the present invention will become apparent and more readily appreciated from the following description of the embodiments, taken in conjunction with the accompany drawings of which:

FIG. 1 is a perspective view of a refrigerator according to an embodiment of the present invention;

FIG. 2 is an exploded perspective view of a door handle assembly in the refrigerator according to an embodiment of the present invention;

FIG. 3 is an assembled perspective view of the door handle assembly of FIG. 2; and

FIGS. 4A through 4C are perspective views illustrating assembling operation of the door handle assembly in the refrigerator according to an embodiment of the present invention.

### DETAILED DESCRIPTION OF THE PREFERRED EMBODIMENT

Reference will now be made in detail to the embodiments of the present invention, examples of which are illustrated in the accompanying drawings, wherein like reference numerals refer to like elements throughout. The embodiments are described below in order to explain the present invention by referring to the figures.

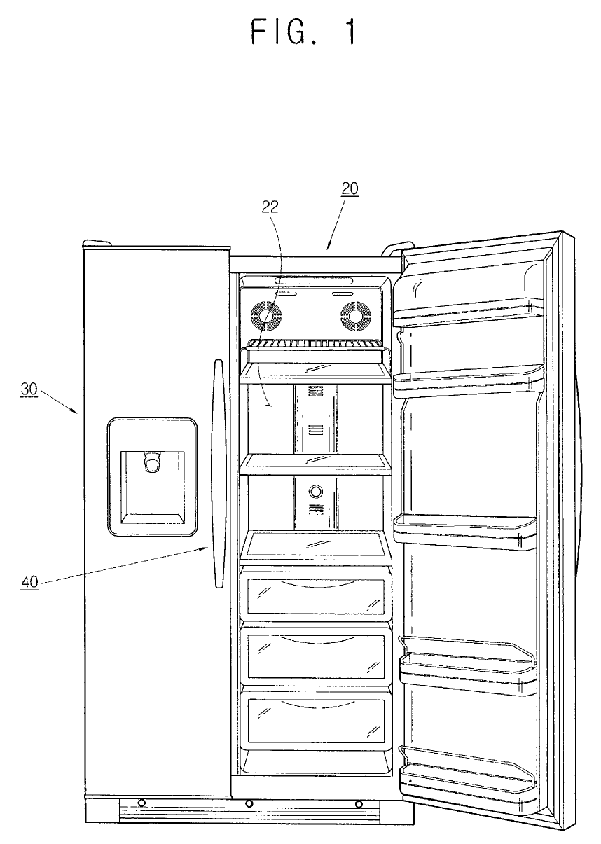

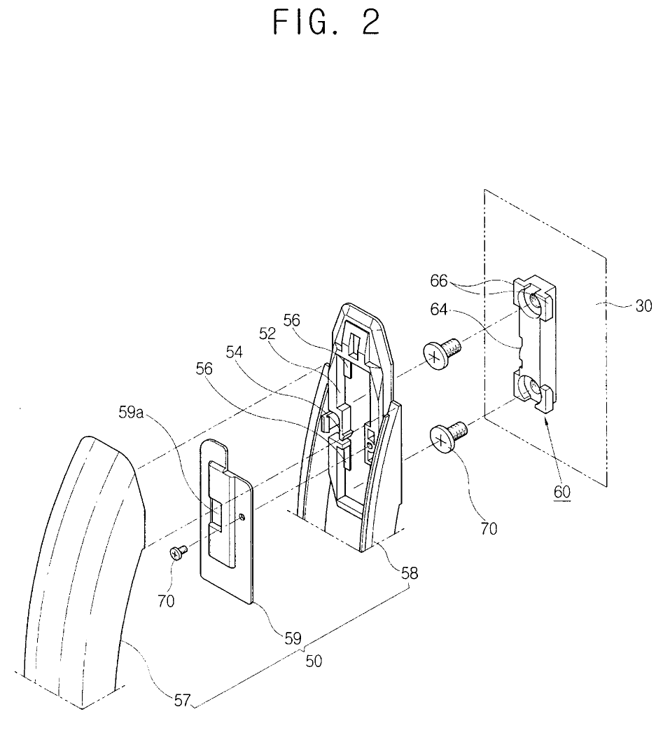

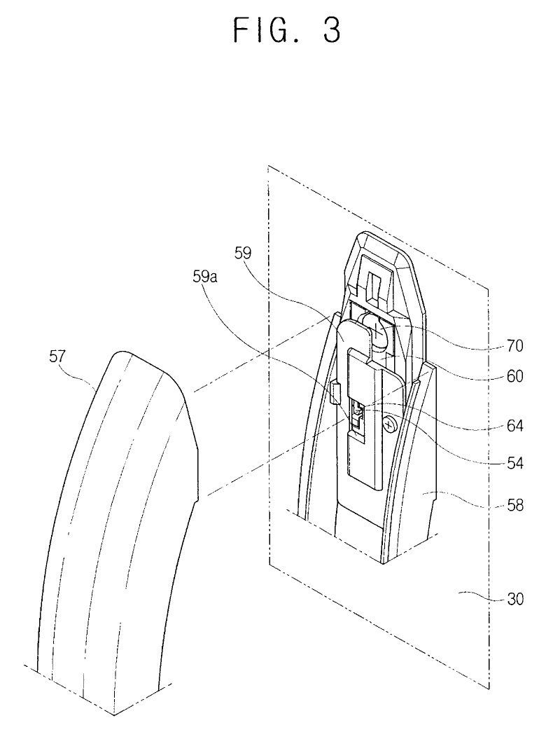

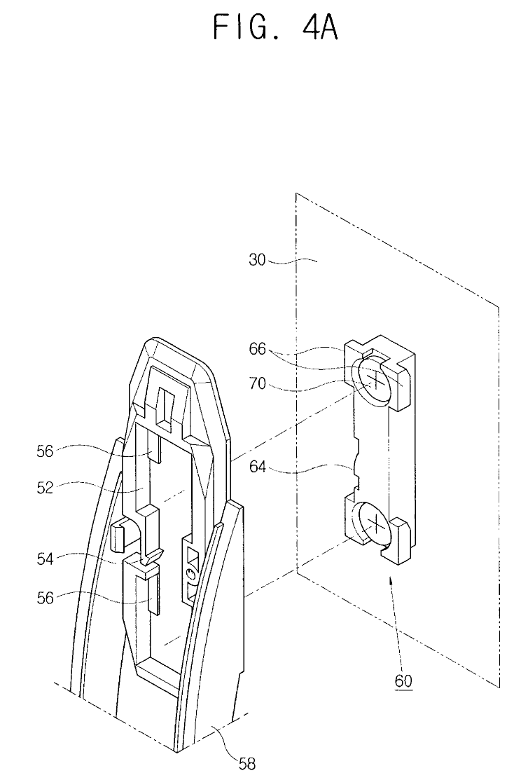

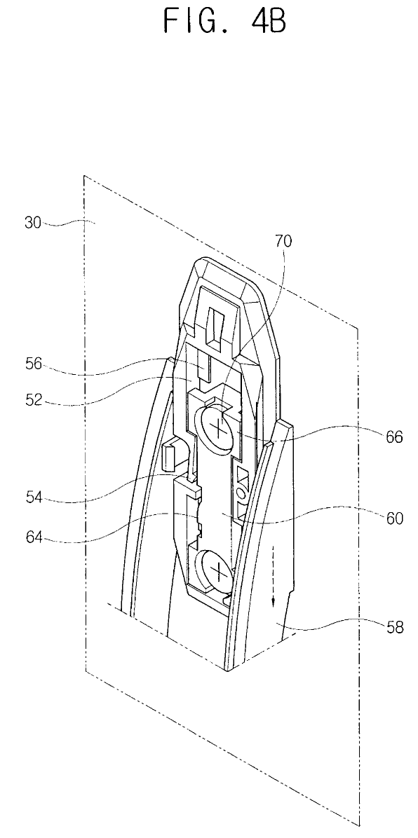

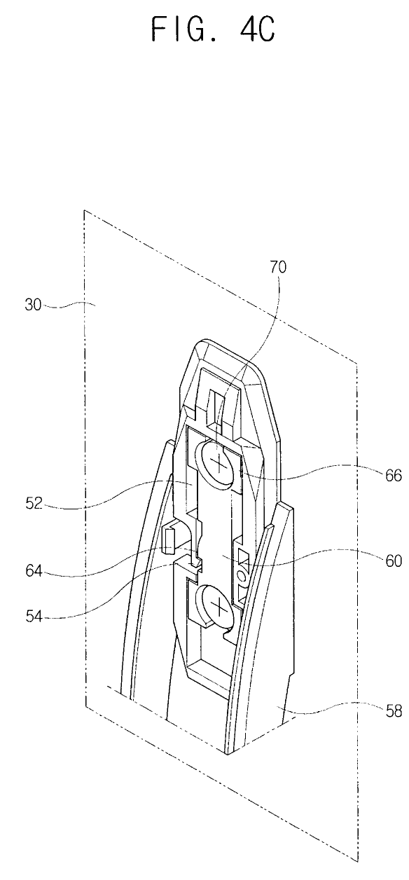

AS shown in FIGS. 1 through 4C, a refrigerator according to an embodiment of the present invention comprises a body 20 provided with storage compartments 22; a door 30 hingedly coupled to the body 20 and selectively opening/closing the storage compartments 22; and a door handle assembly 40 mounted in a front of the door 30.

The structures of the body 20 and the door 30 are the same as well-known structures, and thus their detailed descriptions will be omitted herein.

The door handle assembly 40 is provided to relatively facilitate an opening/closing operation of the door 30 and is detachably coupled to a front portion of the door 30. Here, the size, the shape and the mounting position of the door handle assembly 40 may vary as necessary.

The door handle assembly 40 comprises a door handle 50 formed with a bracket accommodating portion 52 and a first coupling portion 54 adjacent to the bracket accommodating portion 52; and a supporting bracket 60 installed in the front portion of the door 30 to be accommodated in the bracket accommodating portion 52 and having a second coupling portion 64 locked to the first coupling portion 54 when the door handle 50 slides down.

The door handle 50 is shaped like a bow and is firmly coupled to the front portion of the door 30 through opposite ends thereof (here, one of the opposite ends is representatively illustrated in the drawings because the opposite ends are symmetrically formed). Each of the bracket accommodating portions 52 formed in the opposite ends of the door handle 50 has a size enough to accommodate the supporting bracket 60 therein and has a shape varying corresponding to the shape of the supporting bracket 60.

Preferably, the bracket accommodating portion 52 of the door handle 50 is formed integrally with the first coupling portion 54.

The supporting bracket 60 is symmetrically formed with supporters 66 at opposite ends thereof, and the door handle 50 is formed with sliding guides 56, wherein the sliding guides 56 support the supporters 66 of the supporting bracket 60 and prevent the supporting bracket 60 from being separated from the bracket accommodating portion 52 while the door handle 50 slides. The supporting bracket 60 is firmly coupled to the door 30 by a fastener 70 such as a screw or the like, wherein the fastener 70 can be selected from a well-known technology as one having a simple structure and being excellent in fastening effect.

The sliding guide 56 formed in the door handle 50 is placed in consideration of a sliding direction of the door handle 50, that is, whether the door handle 50 slides up or down.

The first coupling portion 54 and the second coupling portion 64 have a hook shape and a protrusion shape, respectively, so that the first coupling portion 54 and the second coupling portion 64 are elastically locked to each other when the door handle 50 slides down. However, the first coupling portion 54 and the second coupling portion 64 may have a protrusion shape and a hook shape, respectively.

The locking structure of the first coupling portion 54 and the second coupling portion 64 can be selected from a well-known technology.

The door handle 50 preferably comprises a front cover 57 forming an outer appearance; and a rear cover 58 detachably coupled with the front cover 57 and formed with the bracket accommodating portion 52, the first coupling portion 54 and the sliding guide 56. Here, the reason why the door handle 50 is divided into the front cover 57 and the rear cover 58 is that the door handle 50 can be easily separated from the supporting bracket 60.

Additionally, there is provided a reinforcing cover 59 detachably connected onto the rear cover 58 in order to improve durability of the door handle 50, wherein the reinforcing cover 59 is formed with a separation hole 59a at a position corresponding to the first coupling portion 54 of the rear cover 58, thereby allowing the rear cover 58 to be easily coupled to and separated from the supporting bracket 60.

The reinforcing cover 59 is firmly coupled to the rear cover 58 by a fastener 70 such as a screw or the like, wherein the fastener 70 can be selected from a well-known technology as one having a simple structure and being excellent in fastening effect.

The separation hole 59a is used to conveniently release the first coupling portion 54 from the second coupling portion 64 without removing the reinforcing cover 59 from the rear cover 58 when the door handle 50 is separated from the supporting bracket 60.

With this configuration, a mounting process of the door handle assembly 40 is as follows. Hereinbelow, an assembling process of the front cover and the rear cover will be omitted.

First, the supporting bracket 60 is securely coupled to the front portion of the door 30 with the fastener 70 such as a screw or the like.

Then, the rear cover 58 is placed allowing the bracket accommodating portion 52 of the rear cover 58 to accommodate the supporting bracket 60 and then slides down allowing the first coupling portion 54 of the rear cover 58 to be elastically locked to the second coupling portion 64 of the supporting bracket 60, thereby completing the mounting process.

At this time, the supporting bracket 60 is prevented from being separated from the rear cover 58 because the supporters 66 formed in the opposite ends of the supporting bracket 60 are supported by the sliding guides 56 of the rear cover 58. Further, the rear cover 58 is prevented from sliding up because the first coupling portion 54 is locked to the second coupling portion 64.

As described above, the present invention provides a refrigerator having an improved structure of mounting a door handle assembly to a door, in which the door handle assembly is easily mounted to and separated from the door and a cost due to packing and carrying the refrigerator is reduced.

Although a few embodiments of the present invention have been shown and described, it will be appreciated by those skilled in the art that changes may be made in these embodiments without departing from the principles and spirit of the invention, the scope of which is defined in the appended claims and their equivalents.

What is Claimed is:

1. A refrigerator comprising a body provided with storage compartments; a door hingedly coupled to the body and selectively opening/closing the storage compartments; and a door handle assembly mounted in a front of the door, the door handle assembly comprising: a door handle formed with a bracket accommodating portion and a first coupling portion adjacent to the bracket accommodating portion; and a supporting bracket installed in the front of the door to be accommodated in the bracket accommodating portion and having a second coupling portion locked to the first coupling portion by sliding the door handle.

2. The refrigerator according to claim 1, wherein the supporting bracket is formed with supporters at opposite ends thereof, and the door handle. is formed with a sliding guide to support the supporters while sliding.

3. The refrigerator according to claim 1, wherein the first coupling portion and the second coupling portion are hook-locked to each other.

4. The refrigerator according to claim 3, wherein the door handle comprises a front cover; and a rear cover detachably coupled with the front cover and formed with the bracket accommodating portion, the first coupling portion and the sliding guide.

5. The refrigerator according to claim 4, further comprising a reinforcing cover detachably connected onto the rear cover, wherein the reinforcing cover is formed with a separation hole at a position corresponding to the first coupling portion of the rear cover.

6. The refrigerator according to claim 2, wherein the first coupling portion and the second coupling portion are hook-locked to each other.

7. The refrigerator according to claim 6, wherein the door handle comprises a front cover; and a rear cover detachably coupled with the front cover and formed with the bracket accommodating portion, the first coupling portion and the sliding guide.

8. The refrigerator according to claim 7, further comprising a reinforcing cover detachably connected onto the rear cover, wherein the reinforcing cover is formed with a separation hole at a position corresponding to the first coupling portion of the rear cover.
